(19) United States
(12) Patent Application Publication
(10) Pub. No.: US 2013/0193927 A1
(43) Pub. Date: Aug. 1, 2013

(54) ELECTROCHEMICAL ENERGY STORAGE DEVICE, BATTERY HAVING AT LEAST TWO SUCH ELECTROCHEMICAL ENERGY STORAGE DEVICES, AND METHOD FOR OPERATING SUCH AN ELECTROCHEMICAL ENERGY STRORAGE DEVICE

(71) Applicant: Tim Schaefer, Harztor (DE)

(72) Inventor: Tim Schaefer, Harztor (DE)

(73) Assignee: LI-TEC BATTERY GMBH, Kamenz (DE)

(21) Appl. No.: 13/744,824

(22) Filed: Jan. 18, 2013

Related U.S. Application Data
(60) Provisional application No. 61/587,708, filed on Jan. 18, 2012.

(30) Foreign Application Priority Data
Jan. 18, 2012 (DE) 102012000872.4

(51) Int. Cl. H02J 7/00; H01M 10/48

(52) U.S. Cl. CPC H02J 7/0068; H01M 10/48
USPC 320/128; 320/127; 429/93

(57) ABSTRACT

Electrochemical energy storage device (1) with at least one electrode assembly, particularly a rechargeable electrode assembly (2), that is designed to at least temporarily supply electrical energy, which electrode assembly has at least two electrodes (3, 3a) of differing polarities, with a functional device (5) that is designed to be electrically connected to the at least two electrodes (3, 3a) of differing polarity, and which is designed to be switchable to a second state, wherein the electrodes (3, 3a) of differing polarity are electrically connected to each other when the functional device (5) is in the second state, with a cell housing (6) that is designed to at least partially surround the electrode assembly (2) and the functional device (5).

The present invention relates to an electrochemical energy storage device, also called a secondary cell, and a method for operating such an electrochemical energy storage device. The invention is described in the context of lithium-ion batteries for powering automotive vehicle drive units. It should be noted that the invention may also be used regardless of the construction type of the battery, the chemistry of the electrochemical energy storage device, or independently of the type of drive unit that is to be powered.

Batteries having a plurality of secondary cells for powering automotive vehicles are known from the related art. Such batteries usually comprise a large number of secondary cells, and the secondary cells are electrically connected to each other. Each of these secondary cells is furnished with at least one rechargeable electrode assembly and a cell housing. The electrode assembly also serves to provide electrical energy, particularly to a consumer. The cell housing serves to accommodate and protect the electrode assembly.

Particularly when they are used in automobiles, but not exclusively operating safety is a very important consideration with respect to such batteries.

The object of the invention is therefore to provide batteries having increased operating safety.

The object is solved with an electrochemical energy storage device according to claim 1. Claim 8 describes a battery having at least two electrochemical energy storage devices. The object is also solved with an operating method according to claim 9 for an electrochemical energy storage device. Preferred refinements of the invention are the object of the respective dependent claims.

An electrochemical energy storage device according to the invention, also referred to hereafter as a secondary cell, has at least one or more particularly rechargeable electrode assemblies. The electrode assembly is provided in order to supply electrical energy at least temporarily particularly to a consumer. The electrode assembly includes at least two electrodes of different polarities. The secondary cell includes at least one or more functional devices that are provided to be electrically connected to the at least two electrodes having different polarities. The functional device is also provided to be converted from a first state to a second state. In the first state, the electrodes of different polarities are electrically insulated from each other. In the second state, the electrodes of different polarities are electrically connected to each other. The secondary cell comprises a cell housing comprising one or more walls, wherein the cell housing is provided to at least partially enclose the electrode assembly and the functional device.

The functional device is preferably arranged between the first wall and the electrode assembly. This design offers the advantage that a foreign body that penetrates the cell housing from the outside and threatens to impact on the secondary cell immediately encounters the functional device as additional protection for the electrode assembly. The functional device particularly preferably covers the inner surface of the first wall essentially completely. This design offers the advantage that the functional device provides improved protection for the electrode assembly regardless of the location where the foreign body impinges on the secondary cell or the cell housing thereof.

The functional device preferably has a predetermined electrical resistance [Ω] particularly in the second state. The electrical resistance is preferably at least 0.5Ω, more preferably at least 1Ω, more preferably at least 2Ω, more preferably at least 5Ω, more preferably at least 10Ω, more preferably at least 20Ω, more preferably at least 50Ω, more preferably at least 100Ω, more preferably at least 200Ω, more preferably at least 500Ω, further preferably not more than 1000Ω. This design offers the advantage that a discharge current that may be drawn from the electrode assembly with the functional device in the second condition may be limited by the functional device. Consequently, the electrical heat output may also be limited. The electrical resistance is particularly preferably adapted to the electrical voltage of the secondary cell or the electrode assembly thereof in such manner that the heat output in the resistor is limited in the second state to not more than 50 W, more preferably not more than 20 W, more preferably not more than 10 W more preferably not more than 5 W, more preferably not more than 2 W, more preferably not more than 1 W.

If a foreign body impacts on a secondary cell, for example in the event of an accident, the secondary cell may be damaged. It has been observed that a secondary cell discharges energy to the surrounding atmosphere in an uncontrolled manner particularly after the cell housing has been damaged. The secondary cell according to the invention offers the advantage that in the second state the functional device limits or controls the cell current and the energy output from the electrode assembly due to its electrical resistance. The secondary cell according to the invention offers the advantage that it enables the energy output from the electrode assembly to be controlled even when only the functional device is damaged by the foreign body. The secondary cell according to the invention offers the advantage that the functional device, which is connected in parallel and electrically conductive in the second state, serves as a second current path in order to reduce the quantity of energy stored in the electrode assembly particularly if the foreign body has penetrated not only the functional device but also the electrode assembly, and particularly if the foreign body has deformed the functional device. In this way, operating safety of the secondary cell, and therewith also the operating safety of the higher level battery is increased and the underlying object is solved.

For the purposes of the present invention, the term electrode assembly is understood to mean a device that serves particularly to provide electrical energy.

The electrode assembly is equipped with at least two electrodes with different polarities. These electrodes with different polarities are separated by a separator, wherein the separator is able to conduct ions but not electrons. The electrode assembly is preferably designed to convert supplied electrical energy into chemical energy and to store it as chemical energy. The electrode assembly is also particularly designed to convert stored chemical energy into electrical energy before the electrode assembly makes this electrical energy available to a consumer. The electrode assembly is preferably essentially cuboid in shape. The electrode assembly is preferably materially connected to two current conducting devices of different polarities, which serve to ensure electrical connection with at least one adjacent electrode assembly and/or at least indirect electrical connection with the consumer.

Preferably at least one of these electrodes is furnished with a collector film, particularly made from metal, and an active mass. The active mass is applied to at least one side of the collector film. During charging or discharging of the electrode assembly, electrons are exchanged between the collector film and the active mass. At least one collector tab is particularly materially connected to the collector film. Particularly preferably, a plurality of collector tabs is connected, particularly materially, to the collector film. This design offers the advantage that the number of electrons flowing through a collector tab per unit of time is reduced.

Preferably, at least one of these electrodes is furnished with a collector film, particularly made from metal, and two active masses of different polarities, which are arranged on different surfaces of the collector film and are separated by the collector film. This arrangement of active masses is also commonly referred to as a “bicell”. When the electrode assembly is charged or discharged, electrons are exchanged between the collector film and the active mass. At least one collector tab is connected, particularly materially, to the collector film. Particularly preferably, a plurality of collector tabs is connected, particularly materially, to the collector film. This variant offers the advantage that the number of electrons that flow through a collector tab per unit of time is reduced.

Two electrodes of different polarity in the electrode assembly are separated by a separator. The separator is ion-permeable but not electron-permeable. The separator preferably contains at least a part of the electrolyte or the conducting salt. The electrolyte is preferably constituted without a liquid component, particularly after the secondary cell is sealed. The conducting salt preferably contains lithium ions. It is particularly preferable if lithium ions are stored or intercalated in the negative electrode during charging and removed taken from the negative electrode again during discharging.

According to a first preferred variant, the electrode assembly has the form of an electrode coil. This variant offers the advantage of being simpler to manufacture, particularly because electrodes in the form of strips can be processed. This variant offers the advantage that the rated charge capacity of the secondary cell, indicated for example in Ampere hours [Ah] or Watt hours [Wh], less frequently in Coulombs [C], can easily be increased by adding further loops. The electrode assembly is preferably designed as a flat electrode coil. This variant offers the advantage that it can be arranged in space-saving manner beside another flat electrode coil in particular inside a battery.

According to a further preferred variant, the electrode assembly is constructed as an essentially cuboid electrode stack. The electrode stack comprises a predetermined sequence of stacked sheets, wherein pairs of electrode sheets include one sheet each of opposite polarity, which are separated by a separator sheet. Each electrode sheet is preferably connected, particularly materially, to a current conductor device, and is particularly preferably constructed integrally with the current conductor device. Electrode sheets having the same polarity are preferably electrically connected to each other, particularly via a common current conductor device. This variant of the electrode assembly offers the advantage that the nominal charge capacity of the secondary cell, indicated for example in Ampere hours [Ah] or Watt hours [Wh], less frequently in Coulombs [C], can easily be increased by adding further electrode sheets. Particularly preferably, at least two separator sheets are connected to each other and enclose a delimiting edge of an electrode sheet. Such an electrode assembly, with a single, particularly serpentine, separator, is described in WO 2011/020545. This variant offers the advantage that a parasitic current flowing from this delimiting edge to an electrode sheet of a differing polarity is neutralised.

For the purpose of the present invention, a cell housing is understood to mean an apparatus that particularly
serves to delimit the electrode assembly and the functional devices from the environment,
serves to protect the electrode assembly from harmful influences from the environment, particularly to protect it from water from the environment,
helps to prevent substances from escaping into the environment from the electrode assembly,
preferably surrounds the electrode assembly and the functional device essentially in gas-impermeable manner.

The cell housing surrounds the electrode assembly at least partially, preferably essentially completely. In this context, the cell housing is adapted to the shape of the electrode assembly. Like the electrode assembly, the cell housing is preferably essentially cube-shaped. For this purpose, the cell housing has at least a first wall. The cell housing preferably surrounds the electrode assembly in such manner that at least one wall of the cell housing, particularly the first wall, exerts a force on the electrode assembly, wherein the force counteracts the force of an undesirable relative movement of the electrode assembly inside the cell housing. The cell housing particularly preferably accommodates the electrode assembly with a positive-locking and/or a force-locking connection. The cell housing is preferably electrically insulated from the environment. The cell housing is preferably electrically insulated from the electrode assembly. At least one inner surface of the cell housing particularly preferably has an electrically insulating coating. This insulating coating offers the advantage that the cell may be constructed from a metallic material, which in turn affords increased protection for the electrode assembly.

The cell housing is preferably constructed in two parts, with a receptacle made particularly from metal to hold the functional device and the electrode assembly and with a cap particularly made from metal to close the receptacle. This design offers the advantage that the cell housing of the electrode assembly affords additional mechanical protection.

For the purpose of the invention, a functional device is understood to mean a device that is intended in particular to be converted to a second state, wherein the electrodes of different polarities are connected to each other electrically when the functional device is in this second state. For this purpose, the electrodes of different polarities are connected electrically to the functional device. In a first state of the functional device, the electrodes of different polarities are electrically insulated from each other. The functional device is designed in such manner that the foreign body that does not belong to the secondary cell, and which impinges on the secondary cell from the external environment is able to convert the functional device to the second state thereof. In the following, this second state of the functional device is also, in the following, designated as short circuit. The foreign body initiates the conversion of the functional device to its second state particularly by:
exerting a force on the cell housing, particularly on the first wall, or
damaging the cell housing or the functional device, or
penetrating the functional device.

The functional device is preferably designed so as to cover at least one or more of the delimiting surfaces or surface areas of the electrode assembly essentially completely. This configuration offers the advantage that the functional device provides improved protection for the electrode assembly regardless of the site where the foreign body is affecting the secondary cell or the cell housing thereof.

The wall thickness of the functional device is preferably less than ⅕ of the thickness of the essentially cuboid electrode assembly. This configuration offers the advantage that the gravimetric energy density [Wh/kg] of the secondary cell is only reduced to an insignificant degree by the functional device.

Preferred configurations and refinements of the invention will be described in the following.

The secondary cell preferably includes at least two functional devices that partially cover opposite delimiting surfaces or surface areas of the electrode assembly in the cell housing, and particularly preferably essentially cover them completely. This configuration offers the advantage that the functional devices improve protection for the electrode assembly regardless of the point at which the foreign body impinges on the secondary cell or the cell housing thereof.

The functional device preferably has at least one or more first potential areas, at least one or more second potential areas, and at least one or more insulating areas. At least one of these first potential areas is insulated from one of these second potential areas by one of these insulating areas. For the purposes of the invention, a potential area is understood to be a device that is electrically conductive and has the electrical potential of one of the electrodes with an electrode assembly. Each of these first and second potential areas is particularly preferably insulated from one another electrically by one of these insulating areas. At least one of these first potential areas is electrically connected to at least one of these electrodes having a first polarity. At least one of these second potential areas is electrically connected to a least one of these electrodes having a second polarity. Particularly preferably, all electrodes with a first polarity are electrically connected to at least one of these first potential areas, and all electrodes with a second polarity are electrically connected to at least one of these second potential areas.

At least one of these insulating areas is preferably constructed as an insulating layer on one of these potential areas. This preferred configuration offers the advantage that the space requirement for the functional device is yet further reduced.

The potential areas and the insulating areas are preferably enclosed in an electrically non-conductive pouch, particularly preferably a polymer pouch. This configuration has the advantage that the functional device is electrically insulated from a cell housing, which may particularly be metallic. The electrically non-conductive pouch particularly preferably comprises a woven or non-woven fabric of reinforcing fibres, particularly aramid fibres, glass fibres, basalt fibres and/or carbon fibres. This configuration offers the advantage that a foreign body that is likely to penetrate the functional device encounters increased mechanical resistance.

Preferably, at least one of these potential areas is puncture-proof, particularly designed as a puncture protection layer. To this end, this potential area comprises:
a woven or non-woven fabric of reinforcing fibres, particularly aramid fibres, and/or
at least one or more metal inserts, which are preferably connected to one another, and/or
at least one or more oxide ceramic inserts, which are preferably in the form of plates.

The preferred variant offers the advantage that this potential area provides increased mechanical resistance to penetration by a foreign body, particularly penetration into the electrode assembly. It is particularly preferred if the potential area that is arranged closer to the electrode assembly is constructed to be puncture-proof and/or in the form of a puncture protection layer. This preferred variant offers the advantage that the mechanical protection of the electrode assembly does not prevent the short circuit in the functional device and the protective effect of the functional device.

At least one of these potential areas preferably has at least one or more electrical conductors or conductive paths as well as a carrier for such conductors or conductive paths. These electrical conductors preferably contain aluminium and/or copper.

Said electrical conductors or conductive paths preferably extend along an edge of the potential area with a predetermined cross sectional area. The electrical resistance of the potential area is also adjustable via the dimensioning of the cross sectional area. Each of the electrical conductors preferably has a resistance of at least 0.1Ω, created particularly by appropriate dimensioning of the cross sections thereof. The electrical conductors or conductive paths are preferably electrically connected to each other and to at least one of these electrodes. This preferred variant offers the advantage that the electrical resistance of the potential area and the functional device is adjustable.

If a foreign body penetrates the functional device, and in so doing also damages the insulating area, the potential areas having different polarity that are adjacent to the insulating area also come into electrical contact with each other. A current path is completed and an electrical connection is established between at least two of these electrodes of different polarity indirectly, i.e. via the potential areas of different polarity. Electrical energy may be drawn from the electrode assembly via this current path. The electrically conductive potential areas R_{P1}, R_{P2} and particularly the electrical contact R_{K} between these potential areas of different polarity, oppose the electrical current, hereafter also referred to as the discharge current, with a cumulative resistance R_{G}, wherein the resistance of electrical contact R_{K} may be significantly greater than the resistances of potential areas R_{P1}, R_{P2}. If the resistance of electrical contact R_{K} represents the largest fraction of cumulative resistance R_{G}, the electrical energy drawn from the electrode assembly there is then converted into thermal energy. In this case, the potential areas, which are capable of conducting both electrical and thermal energy, serve to distribute the thermal energy.

This insulating area is preferably furnished with at least one or more openings, which serve to enable electrical contact between the first potential area and the second potential area. If the foreign body deforms this functional device, particularly the potential area of the functional device facing the cell housing, hereafter also referred to as the outer potential area, an electrical contact may be created between the first potential area and the second potential area through one of these openings even if the foreign body does not penetrate the functional device. In such an instance, at least one of these potential areas protrudes through this opening towards one of the other potential areas. This configuration offers the advantage that the functional device may be switched to the second state even if it is not penetrated by the foreign body, particularly if the functional device undergoes deformation only. This insulating area is particularly preferably equipped with an array of openings. This configuration offers the advantage that by virtue of the functional device the protection of the electrode assembly is improved regardless of location where the foreign body impinges on the secondary cell or the cell housing thereof.

The functional device preferably includes a substance designed to react with hydrogen fluoride, particularly preferably calcium chloride. This configuration offers the example that hydrogen fluoride may be bonded inside the cell housing.

The functional device is preferably furnished with a layer of Separion®, which is arranged adjacent to the electrode assembly, particularly between the electrode assembly and the insulating area. This configuration has the advantage that when the functional device is in the second state or when the electrode assembly is discharging, heat is prevented from being introduced into the electrode assembly.

A first preferred embodiment of this functional device comprises a first potential area and a second potential area, which are preferably in the form of metal foils. The insulating area has the form of an insulating film, preferably a polymer film or paper, and is arranged between the two potential areas. The electrodes with the first polarity are electrically connected to the first potential area and the electrodes with the second polarity are electrically connected to the second potential area. The dimensions of the functional device are such that the inner side of at least one wall of the cell housing, or the surface area of the electrode assembly is essentially completely covered by the functional device. The potential areas and the insulating area are preferably surrounded by an electrically non-conductive pouch, particularly preferably a polymer pouch. This configuration offers the advantage that the functional device is electrically insulated from a cell housing, which in particular is metallic. This embodiment offers the advantage that the functional device only occupies a small space in the cell housing. This embodiment offers the advantage that the functional device may be manufactured inexpensively. The dimensions of the functional device are such that at least two or three adjacent surface areas of the electrode assembly are essentially completely covered. This variant offers the advantage that the functional devices improve protection for the electrode assembly largely independently of the location where the foreign body impinges on the secondary cell or the cell housing thereof.

A second preferred embodiment of the functional device essentially corresponds to the preferred embodiment described in the preceding, with the exception that one of these potential areas, facing the electrode assembly, is designed to be puncture-proof, and particularly has the form of a puncture protection layer. This potential area also has a carrier, particularly a base layer, on which a plurality of electrical conductors are arranged to face the insulating area. The multiple electrical conductors each have a predetermined electrical resistance of at least 0.1Ω. This preferred embodiment offers the advantage that the functional device affords mechanical protection for the electrode assembly. This preferred embodiment offers the advantage that when in the second state the functional device limits the discharge current.

A third preferred embodiment of the functional device essentially corresponds to the one of the preferred embodiments described in the preceding, with the exception that at least one of these insulating areas is furnished with at least one or more openings. This embodiment offers the advantage that the functional device may be switched to the second state even without penetration by a foreign body, particularly if the functional device is only deformed.

A preferred refinement of the preferred embodiments of the functional device described in the preceding comprises a stack of first potential areas, second potential areas and insulating areas. The stack includes a plurality of sequences of one of these first potential areas, one of these insulating areas and one of these second potential areas. This preferred refinement offers the advantage that as the foreign body penetrates farther, more insulating areas are damaged, and multiple current paths are formed, so that the heat output of the discharge current is distributed.

The secondary cell preferably comprises at least one of the following devices:
a current conducting device, preferably two current conducting devices of different polarity, which serve to conduct electrons between one of the electrodes of the electrode assembly and a consumer or between one of the electrodes and an adjacent secondary cell, which are electrically connected, preferably materially, to one of the electrodes of the electrode assembly, each of which is preferably designed to extend at least partly out of the cell housing, and each of which preferably has a connection area outside of the cell housing particularly for connecting to the consumer or an adjacent secondary cell,
a sheath that is provided to surround the electrode assembly particularly inside the cell housing, which particularly inhibits the exchange of chemical substances with the environment, which particularly inhibits the escape of chemical substances from the electrode assembly, which particularly electrically insulates the electrode assembly from the cell housing,
a second, particularly rechargeable, electrode assembly, which is provided to make electrical energy available at least temporarily, particularly to the same consumer, which is preferably connected to the first electrode assembly particularly inside the cell housing, and is particularly preferably connected in series, which particularly serves to increase the nominal voltage of the secondary cell, which preferably has the same construction as the first electrode assembly,
a discharge resistor that is connected between one of these potential areas and one of these electrodes, which is preferably connected particularly in thermally conductive manner to the cell housing, which particularly serves to limit the discharge current when the functional device is in the second state, which is preferably constructed as a PTC thermistor,
a display device, which is provided particularly to display the second state of the functional device and/or to communicate an indication of such second state, particularly to display a short circuit between the first potential area and the second potential area and/or to communicate an indication of such short circuit, which has the form of a bleeper, a light emitting diode, infrared interface or a GSM assembly,
one or more sensors, each of which is provided to capture one operating parameter of the secondary cell, particularly of the electrode assembly, which particularly have the form of voltage sensors, current sensors, temperature sensors or thermocouples, pressure sensors, sensors for a chemical substance, hereafter referred to as “substance sensors”, gas sensors, liquid sensors, position sensors or acceleration sensors, wherein the sensors or gauges serve particularly to capture operating parameters of the secondary cell, particularly of the electrode assembly, each of which serves to provide a signal, wherein the signal enables a conclusion to be drawn regarding an operating parameter of the secondary cell,
a cell control device, which is provided for controlling the secondary cell or the electrode assembly, which serves particularly for processing at least one signal from one of these sensors, particularly the sensors described in the preceding,
a first short-range radio device, which is provided to enable communication with a higher-level controller, particularly a battery controller, which serves to transmit data particularly to a battery controller or an independent controller, which serves particularly to provide notification of a predetermined operating state of the secondary cell or electrode assembly or of the functional device.

The sheath preferably comprises a composite film having at least two layers. The first of these layers, particularly the layer facing the outside environment, contains a polymer. This first layer is preferably designed as a polymer film. The second of these layers, particularly the layer facing the electrode assembly, includes a metal, preferably aluminium. This second layer particularly preferably has the form of a metal foil.

For the purposes of the invention, a current conducting device is understood to be a device that serves particularly to conduct electrons between one of the electrodes of the electrode assembly and a consumer or between one of the electrodes and an adjacent secondary cell. For this purpose, the current conducting device is electrically connected, preferably by a material connection, to one of the electrodes of the electrode assembly. The current conducting device is preferably at least indirectly connected to a consumer that is to be supplied with power.

The current conducting device is furnished with an electrically conductive area including a metal material, preferably aluminium and/or copper, portions of which are particularly preferably covered with a nickel coating. This variant offers the advantage of a lower contact resistance. The current conducting device is preferably of solid construction and made from a metal material. The material of the current conducting device preferably corresponds to the material of the collector film of the electrode, to which the current conducting device is in particular connected materially. This variant offers the advantage of reduced contact corrosion between the current conducting device and the collector film.

The current conducting device is furnished with a second area which extends towards the electrode assembly inside the secondary cell. The second area is electrically connected, preferably by a material connection, to at least one electrode of the electrode assembly, preferably to all electrodes with the same polarity.

The second area is preferably equipped with at least one collector tab. The collector tab is connected, particularly by a material connection, to one of the electrodes of the electrode assembly, particularly to the collector film thereof. The collector tab has the form of an electrically conductive band, preferably a metal foil. This variation offers the advantage that a misalignment between a plane of symmetry through the area of the current conductor device which extends into the environment of the secondary cell and a plane through this electrode or collector film may be compensated. The second area is particularly preferably furnished with a plurality of collector tabs. The collector tabs make multiple current paths available to the same electrode, thereby advantageously lowering the current density of the current path, or to different electrodes having the same polarity in the electrode stack, thereby forming a parallel circuit of the electrodes having the same polarity.

The current conductor device is preferably furnished with a first area that extends into the environment of the secondary cell. The first area is electrically connected at least indirectly to a consumer that is to be supplied with power or to a second, particularly adjacent secondary cell, particularly via a connecting device, preferably via a conductor rail, a conductor line or a connection cable. According to a preferred variant, the first area is in the form of a metal plate or a plate with a metallic coating. This variant offers the advantage that an essentially flat surface is provided for the simple electrical connection to a connecting device.

The current conductor device preferably comprises an essentially plate-like metal current conductor. In the second area of the current conductor device, the current conductor is connected particularly by a material connection particularly to all collector tabs having the same polarity. The material from which this current conductor is made preferably corresponds to the material of the collector tab. This variant offers the advantage that the current conductor may be of a more mechanically stable construction for connecting to a connecting device than would be possible with a film-type collector tab. This improves the durability of the secondary cell. This variant offers the further advantage that the current conductor may be connected to the cell housing before the electrode assembly, with attached collector tabs, is fed to the cell housing. Particularly preferably, the current conductor also extends into the first area of the current conductor device and in particular is constructed as a metal plate and/or pressed sheet metal part. This variant offers the advantage of low production costs. This variant offers the further advantage that the current conductor device is sufficiently mechanical stable in the first area to form a connection with a connection device not associated with the secondary cell, for example a conductor rail, a conductor line or a connection cable.

For the purposes of the invention, an operating parameter is understood to be a parameter particularly of the secondary cell that in particular
enables a conclusion to be drawn about the existence of a desired and/or predetermined operating state of the secondary cell or the electrode assembly thereof, and/or
enables a conclusion to be drawn about the existence of an unplanned or undesirable operating state of the secondary cell or the electrode assembly thereof, and/or
enables detection preferably of an electrical voltage or electrical current with the aid of a sensor, wherein the sensor at least temporarily provides a signal, and/or
is processable by a control device, particularly a cell control device, may particularly be compared with a target value, may particularly be linked with another captured parameter, and/or
enables information to be derived about the cell voltage, the cell current, i.e. the strength of electric current to or from the electrode assembly, the cell temperature, the internal pressure in the cell, the integrity of the cell, the escape of a substance from the electrode assembly, the presence of a foreign substance particularly from the environment of the secondary cell and/or its charge status, and/or
provides advice regarding switching of the secondary cell to a different operating state.

The at least one sensor preferably has the form of: a voltage sensor, a current sensor, a temperature sensor or thermocouple, a pressure sensor, a sensor for a chemical substance, hereafter referred to as “substance sensor”, a gas sensor, a liquid sensor, a position sensor or acceleration sensor, wherein the sensors serve particularly to capture operating parameters of the secondary cell, particularly of the electrode assembly.

The cell control device is provided to control at least one operating process of the secondary cell, particularly to control the charging and/or discharging of the electrode assembly. The cell control device preferably monitors an operating state of the secondary cell. The cell control device preferably initiates switching of the secondary cell to a predetermined operating state. The cell control device preferably displays the state of the secondary cell via a display device, particularly at least one LED. This preferred variant offers the advantage that the cell control device is arranged and protected in the first housing section. This preferred variant offers the further advantage that the secondary cell includes a dedicated cell control device for operating and monitoring the electrode assembly, which also remains with the secondary cell when the secondary cell is removed from a battery.

The cell control device is preferably provided to initiate switching of the secondary cell to a “safe” state, wherein charging of the secondary cell in the safe state corresponds to not more than half of nominal charge capacity, wherein particularly in the safe state the cell voltage is not more than 3 V. This preferred variant offers the advantage that the safe state of the secondary cell may also be achieved outside of a battery pack.

The discharge resistance preferably has the form of a PTC thermistor. This variant offers the advantage of improved control of the discharge current by reducing the discharge current as the temperature of the PTC thermistor rises.

The first short-range radio device is preferably provided to temporarily transmit a predetermined signal, particularly in response to a predetermined first signal or request from a second short-range radio device, wherein the second short-range radio device is connected by a signal to a battery controller. The first short-range radio device is particularly preferably provided to transmit an identifier for the secondary cell simultaneously with the predetermined second signal.

These first and second potential areas are preferably not connected directly to these electrodes having different polarity, but only indirectly via at least two of these current conductor devices. Accordingly, at least one or more of these first potential areas are electrically connected with a first of these current conductor devices, and at least one or more of these second potential areas are electrically connected with a second of these current conductor devices, particularly inside the cell housing, particularly outside of the sheath of the electrode assembly. This variant offers the advantage that the construction of this electrode assembly, this sheath, or the current conductor devices does not have to be adapted to the functional device. Consequently, warehousing costs and/or logistical expenditure are saved.

The secondary cell preferably has a nominal charge capacity of at least 3 Ampere hours [Ah], more preferably at least 5 Ah, more preferably at least 10 Ah, more preferably at least 20 Ah, more preferably at least 50 Ah, more preferably at least 100 Ah, more preferably at least 200 Ah, further preferably not more than 500 Ah. This variant offers the advantage of improved operating life of the consumer that is powered by the secondary cell.

The secondary cell preferably has a nominal current of at least 50 A, more preferably at least 100 A, more preferably at least 200 A, more preferably at least 500 A, further preferably not more than 1000 A. This variant offers the advantage of improved performance of the consumer that is powered by the secondary cell.

The secondary cell preferably has a nominal voltage of at least 1.2 V, more preferably at least 1.5 V, more preferably at least 2 V, more preferably at least 2.5 V, more preferably at least 3 V, more preferably at least 3.5 V, more preferably at least 4 V, more preferably at least 4.5 V, more preferably at least 5 V, more preferably at least 5.5 V, more preferably at least 6 V, more preferably at least 6.5 V, more preferably at least 7 V, further preferably not more than 7.5 V. The electrode assembly preferably contains lithium ions. This variant offers the advantage of improved energy density of the secondary cell.

The secondary cell preferably has an operating temperature range between −40° C. and 100° C., more preferably between −20° C. and 80° C., more preferably between −10° C. and 60° C., more preferably between 0° C. and 40° C. This variant offers the advantage of the widest possible range of installations and uses of the secondary cell for powering a consumer, particularly in an automotive vehicle or a stationary system or machine.

The secondary cell preferably has a gravimetric energy density of at least 50 Wh/kg, more preferably at least 100 Wh/kg, more preferably at least 200 Wh/kg, further preferably less than 500 Wh/kg. The secondary cell preferably contains lithium ions. This variant offers the advantage of improved energy density of the secondary cell.

According to a preferred embodiment, the secondary cell is designed for installation in a vehicle equipped with at least one electric motor. The secondary cell is preferably designed to power this electric motor. The secondary cell is particularly preferably designed to at least temporarily power an electric motor in a drivetrain of a hybrid or electric motor vehicle. This variation offers the advantage of improved power supply to the electric motor.

According to a further preferred embodiment, the secondary cell is designed for use in a stationary battery, particularly in a buffer storage system, as a device battery, an industrial battery or starter battery. The nominal charge capacity of the secondary cell for these applications is preferably at least 3 Ah, particularly preferably at least 10 Ah. This variation offers the advantage of improved power supply to a stationary consumer, particularly a stationary mounted electric motor.

According to a first preferred embodiment, the at least one separator, which conducts electrons only poorly or not at all, is made from a carrier that is at least partially substance-permeable. The carrier is preferably coated on at least one side with an inorganic material. The at least partially substance-permeable material used for the support is preferably an organic material preferably in the form of a non-woven fabric. The organic material, which preferably contains a polymer and particularly preferably contains polyethylene terephthalate (PET), is coated with an inorganic, preferably ion-conducting material that is also preferably ion-conducting in a temperature range from −40° C. to 200° C. The inorganic material preferably contains at least one compound from the group of oxides, phosphates, sulphates, titanates, silicates, aluminosilicates with at least one of the elements Zr, Al, Li, particularly preferably zirconium oxide. Zirconium oxide particularly promotes the material integrity, nanoporosity and flexibility of the separator. The inorganic, ion-conducting material preferably contains particles having a diameter smaller than 100 nm. This embodiment offers the advantage that the stability of the electrode assembly at temperatures above 100° C. is improved. Such a separator is marketed in Germany for example by Evonik AG with the brand name “Separion”.

According to a second preferred embodiment, the at least one separator, which conducts electrons only poorly or not at all, consists at least mainly or entirely of a ceramic, preferably an oxide ceramic. This embodiment offers the advantage that the stability of the electrode assembly at temperatures above 100° C. is improved. A secondary battery preferably comprises at least two secondary cells or preferred variants thereof according to the invention. The secondary battery also includes a battery controller and preferably a second short-range radio device. The second short-range radio device is preferably connected by signalling means to one such first short-range radio device of one of these secondary cells.

The second short-range radio device is particularly preferably designed to temporarily transmit a predetermined first signal, to which a first of these short-range radio devices responds with a predetermined signal. This variant offers the advantage that the functional capability of secondary cells of the battery may be queried with the second short-range radio device.

The battery controller is particularly preferably designed such that after receiving a predetermined second signal from one such first short-range radio device of one of the secondary cells it connects this secondary cell to the power supply circuit of a connected consumer via the second short-range radio device. This variant offers the advantage that the replacement of a secondary cell is made easier.

### Preferred Embodiments Of The Secondary Cell According To The Invention

A first preferred embodiment of the secondary cell comprises one of such particularly essentially cuboid electrode assemblies, of such cell housings and at least one of such functional devices according to the first preferred embodiments thereof. The electrode assembly includes at least two electrodes having differing polarities. The electrode assembly is surrounded by such a sheath inside the cell housing. The secondary cell further includes two such current conductor devices, which protrude partly out of the cell housing and which each have a connection area outside of the cell housing. The current conductor devices are connected between a first and second of such potential areas of the functional device and these electrodes having differing polarity. The functional device is arranged between such an electrode assembly and one of such walls of the cell housing. The functional device includes one of such first and one of such second potential areas, which are preferably in the form of metal foils. The functional device also has an insulating area that is arranged between the first and second potential areas and preferably comprises the form of a polymer film.

This preferred embodiment offers the advantage that when the functional device is in the second state, the electrical resistance thereof limits or controls the output of energy from the electrode assembly, i.e. the cell current. This preferred embodiment offers the advantage that the controlled output of energy from the electrode assembly is enabled even when only the functional device is damaged by the foreign body. This preferred embodiment offers the advantage that when connected in parallel and in the second state, the functional device serves as a second current path for dissipating the energy stored in the electrode assembly, particularly if the foreign body has penetrated both the functional device and the electrode assembly, particularly if the foreign body has deformed the functional device.

A second preferred embodiment of the secondary cell is essentially the same as the first preferred embodiment, except that one of such discharge resistors is connected between the potential area farthest from the electrode assembly and the current conductor device connected thereto. The discharge resistor serves in particular to limit the discharge current when the functional device is in the second state and preferably has the form of a PTC thermistor. The electrical resistance of the discharge resistor is preferably at least 0.5Ω, more preferably at least 1Ω, more preferably at least 2Ω, more preferably at least 5Ω, more preferably at least 10Ω, more preferably at least 20Ω, more preferably at least 50Ω, more preferably at least 100Ω, more preferably at least 200Ω, more preferably at least 500Ω, further preferably not more than 1000Ω. This preferred embodiment further comprises at least one LED, which is designed to display whether the functional device has to be or has been switched to the second state.

This preferred embodiment offers the advantage that in the second state, the discharge resistor limits or controls the energy output from the electrode assembly, i.e. the cell current. This preferred embodiment offers the advantage that the controlled output of energy from the electrode assembly is enabled even when only the functional device is damaged by the foreign body. This preferred embodiment offers the advantage that when connected in parallel and in the second state, the electrically conductive functional device serves as a second current path for dissipating the energy stored in the electrode assembly, particularly if the foreign body has penetrated both the functional device and the electrode assembly, particularly if the foreign body has deformed the functional device. This preferred embodiment offers the advantage that it is evident from the outside whether the functional device is to be or has been switched to the second state.

This discharge resistance is preferably in thermally conductive contact with the cell housing. This variant offers the advantage that the heat output generated during the electrode assembly discharge process may be distributed throughout the cell housing.

A third preferred embodiment of the secondary cell is essentially the same as the first preferred embodiment, except that it comprises two essentially cuboid electrode assemblies and two functional devices. The electrode assemblies are arranged adjacent to one another inside the cell housing and are preferably connected to one another in series. The dimensions of the functional devices are such that each such device essentially completely covers at least two or three inner surfaces of the cell housing.

This preferred embodiment offers the advantage that when in the second state, the functional device limits or controls the output of energy from the electrode assembly, i.e. the cell current, by its electrical resistance. This preferred embodiment offers the advantage that the controlled energy output from the electrode assembly is enabled even when only the functional device is damaged by the foreign body. This preferred embodiment offers the advantage that when connected in parallel and in the second state the electrically conductive functional device serves as a second current path for dissipating the energy stored in the electrode assembly, particularly if the foreign body has penetrated both the functional device and the electrode assembly, particularly if the foreign body has deformed the functional device. This preferred embodiment offers the advantage of increased cell voltage. This preferred embodiment offers the advantage that the protection of the electrode assembly is improved regardless of the location where the foreign body impinges on the secondary cell or the cell housing thereof.

### Methods of Operation

For increased operating safety, a secondary cell, particularly designed according to any one of claims 1-7, is operated according to any one of the following methods of operation. The secondary cell comprises at least:
an electrode assembly, particularly a rechargeable electrode assembly, that is designed to at least temporarily supply particularly a consumer with electrical energy, which electrode assembly has at least two electrodes of differing polarity,
a functional device that is designed to be electrically connected to the at least two electrodes of differing polarity, and which is designed to be switchable to a second state, wherein the electrodes of differing polarity are connected to each other when the functional device is in the second state, which functional device preferably has a first and a second potential area,
a cell housing that is designed to at least partially enclose the electrode assembly and the functional device
preferably two such current conductor devices,
preferably one such discharge resistor,
preferably one LED,
preferably one such cell control device.

The first method of operation serves particularly to switch the functional devices to the second state. This first method of operation is characterized by
(S1) penetrating of the functional device by a foreign body that does not belong to the secondary cell, particularly from the surroundings of the secondary cell, particularly in response to which the functional device is switched to the second state, and/or
(S2) electrical connecting of the first potential area to the second potential area of said functional device, particularly due to the foreign body that does not belong to the secondary cell, particularly in response to which the functional device is switched to the second state.

If a foreign body impinges on the secondary cell, for example in the event of an accident, the secondary cell may be damaged. It has been observed that a secondary cell discharges energy to the surrounding atmosphere in an uncontrolled manner particularly after the cell housing has been damaged. The method according to the invention offers the advantage that the energy discharge from the electrode assembly or cell current is limited and controlled by the electrical resistance of the functional device. The method according to the invention offers the advantage that the energy output from the electrode assembly is controlled even when only the functional device is damaged by the foreign body. The method according to the invention offers the advantage that the energy stored in the electrode assembly may be dissipated via the electrically conductive functional device that is in the second state and connected in parallel particularly if the foreign body has penetrated not only the functional device but also the electrode assembly, and particularly if the foreign body has deformed the functional device. In this way, operating safety of the secondary cell, and therewith also the operating safety of the higher level battery, is increased and the underlying problem is solved

The second method of operation serves particularly to switch the electrode assembly to a third state, particularly from the second state of the functional device. The second method of operation is characterized by
(S3) dissipating of an electrical current, also referred to as the discharge current, from the electrode assembly, particularly during a predetermined second time interval, particularly by the functional device, particularly via the discharge resistor of the secondary cell, particularly in response to which the electrode assembly is switched to the third state.

The electrode assembly is switched to the third state at the end of the second time interval. This third state is characterized in that the electrode assembly has a predetermined residual charge that is lower than the nominal charge capacity of the secondary cell.

The cell control device monitors step S3. An LED preferably indicates that the switch of the electrode assembly to the third stage has been initiated and completed.

The predetermined second time interval is preferably at least 10 s, more preferably 20 s, more preferably 50 s, more preferably 100 s, more preferably 200 s, more preferably 1000 s, further preferably less than 1 h.

According to a first preferred variant of this method of operation, the predetermined residual charge is not more than 90% of the nominal charge capacity, more preferably not more than 80%, more preferably not more than 70%, more preferably not more than 60%, more preferably not more than 50%, more preferably not more than 40%, more preferably not more than 30%, more preferably not more than 20% further preferably not less than 5%.

According to a further preferred variant of this method of operation, the predetermined residual charge is defined by the open circuit voltage of the secondary cell, wherein the open circuit voltage with residual charge is preferably not more than 3.5 V, more preferably not more than 3 V, more preferably not more than 2.8 V, more preferably not more than 2.6 V, more preferably not more than 2.4 V, more preferably not more than 2.2 V, more preferably not more than 2 V, more preferably not more than 1.5 V, more preferably not more than 1.2 V, more preferably not more than 1 V, more preferably not more than 0.5 V, further preferably not less than 0.2 V.

The method according to the invention offers the advantage that the energy discharge from the electrode assembly, i.e. the cell current, is limited and controlled by the electrical resistance of the functional device. The method according to the invention offers the advantage that the energy discharge from the electrode assembly is controlled even when only the functional device is damaged by the foreign body. The method according to the invention offers the advantage that the energy stored in the electrode assembly may be dissipated via the electrically conductive functional device that is connected in parallel and in the second state, particularly if the foreign body has penetrated both the functional device and the electrode assembly, particularly if the foreign body has deformed the functional device. In this way, operating safety of the secondary cell, and therewith also the operating safety of the higher level battery is increased and the underlying problem is solved

A secondary cell that is constructed according to the previously described second preferred embodiment, i.e. with one of such discharge resistors and an LED, is particularly suitable for operation according to this second method of operation. This preferred variant offers the advantage that the energy output from the electrode assembly, i.e. the cell current, is limited and controlled by the electrical resistance of the discharge resistor. This preferred embodiment offers the advantage that it is evident from the outside whether the functional device is to be or has been switched to the second state

Further advantages, features and application possibilities of the present invention will be evident from the following description in conjunction with the drawing. In the drawing:

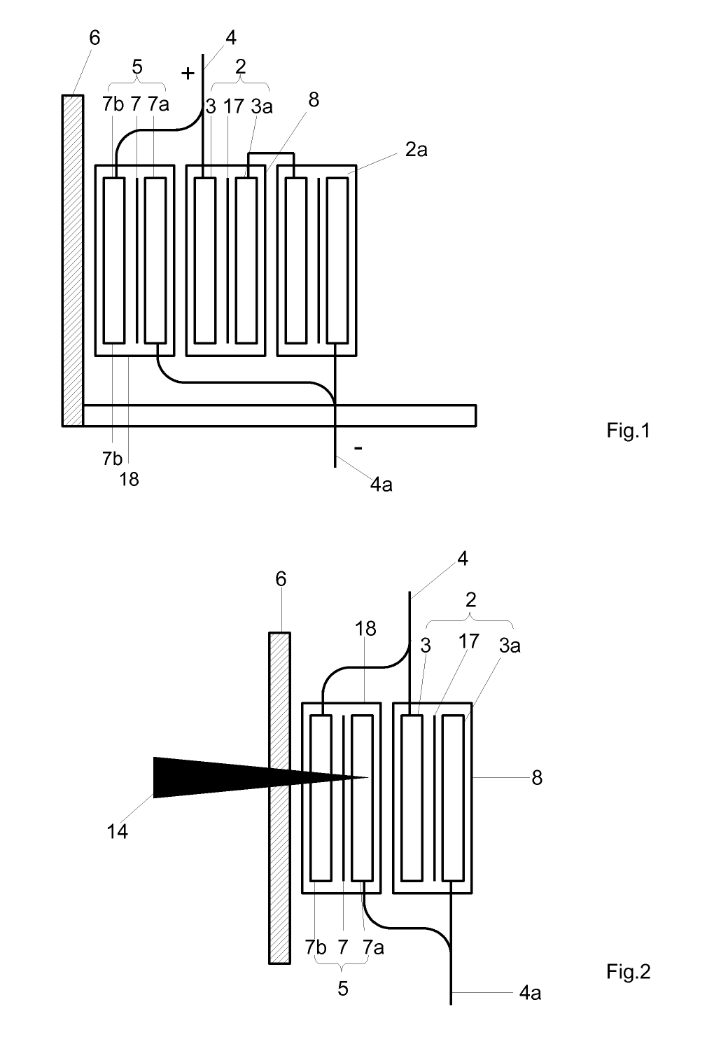

FIG. 1 is a schematic view of a detail of a preferred embodiment of a secondary cell according to the invention,

FIG. 2 is a schematic view of a detail of a further preferred embodiment of a secondary cell according to the invention, in which the foreign body has penetrated the cell housing,

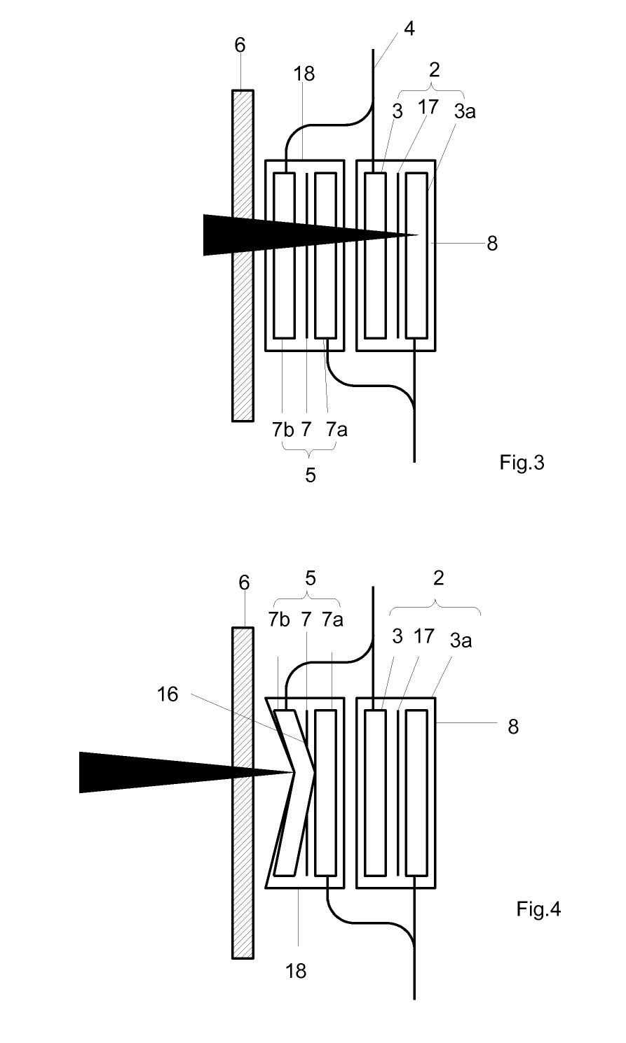

FIG. 3 is a schematic view of the secondary cell of FIG. 2, in which the foreign body has penetrated the electrode assembly,

FIG. 4 is a schematic view of a further preferred embodiment of a secondary cell according to the invention, in which the foreign body is deforming the functional device,

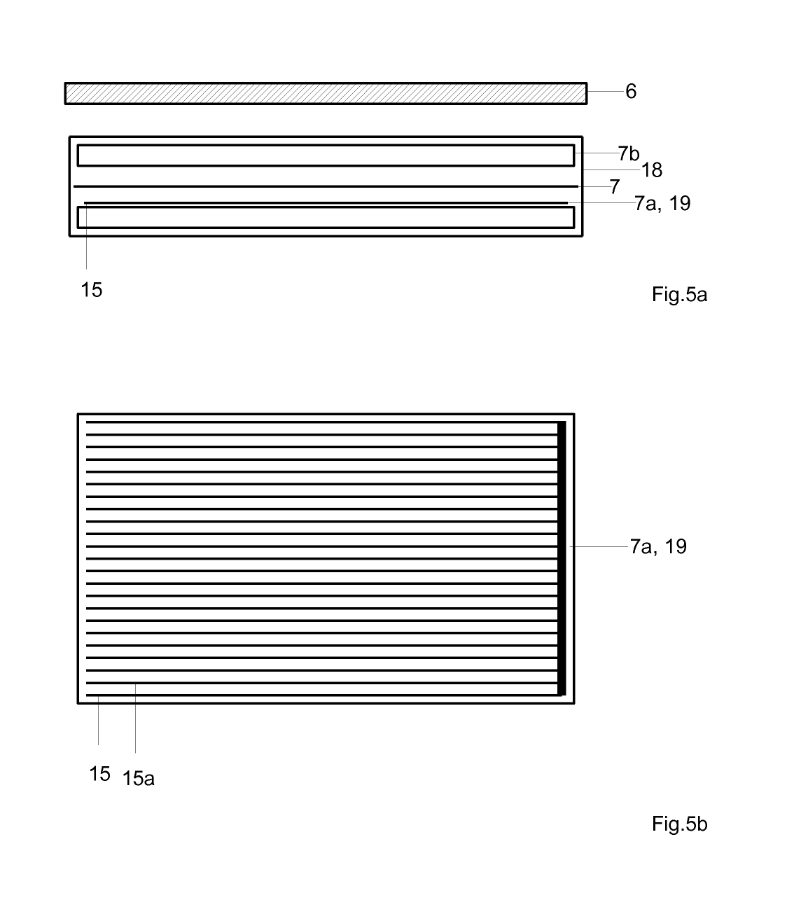

FIG. 5 is a schematic view of a detail of a preferred embodiment of the functional device with a puncture-protection layer and an arrangement of electrical conductors,

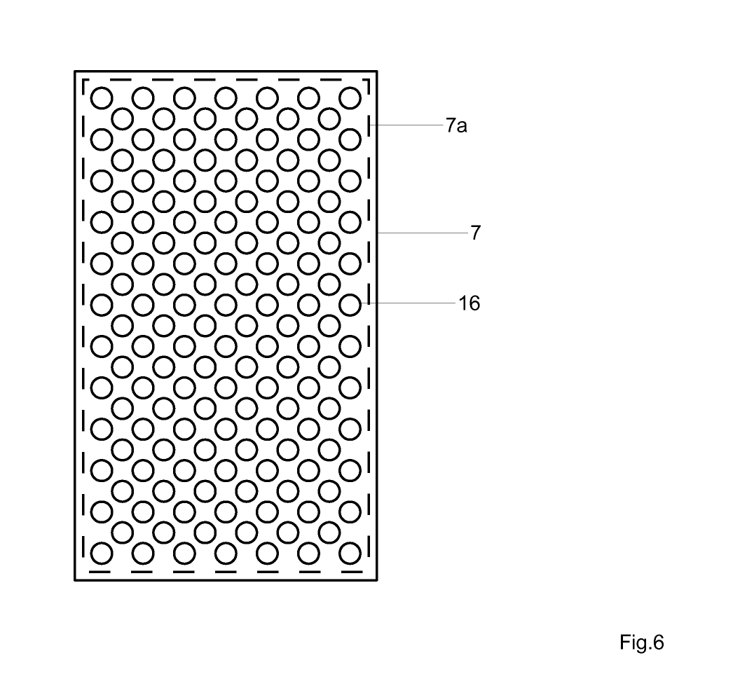

FIG. 6 is a schematic view of a further preferred embodiment of the functional device, in which the insulating area is furnished with openings.

FIG. 1 shows a schematic view of a secondary cell 1 according to the invention. Secondary cell 1 comprises two electrode assemblies 2, 2a, a functional device 5, a cell housing 6 and two current conductor devices 4, 4a. The two electrode assemblies 2, 2a are connected in series and arranged adjacent to one another inside cell housing 6. The two electrode assemblies 2, 2a are each furnished with a sheath 8. Functional device 5 has a first potential area 7a, a second potential area 7b and an insulating area 7, wherein insulating area 7 separates the potential areas. Potential areas 7, 7a are electrically connected to current conductor devices 4, 4a. Functional device 5 is surrounded by a polymer pouch 18 and arranged between first electrode assembly 2 and cell housing 6. Potential areas 7a, 7b preferably have the form of metal foils and insulating area 7 is preferably in the form of a polymer film. Cell housing 6, functional device 5 and electrode assembly 2 are shown separately from each other only so that they can be distinguished more easily. This embodiment offers the advantage that the nominal voltage of the secondary cell is increased. This embodiment offers the advantage of greater operating safety of the secondary cell, due to the fact that functional device 5 provides further mechanical protection for electrode assembly 2 against penetration by a foreign body 14. This embodiment offers the advantage of greater operating safety of the secondary cell, due to the fact that functional device 5 may serve as a current path for the at least partial discharge of electrode assembly 2.

FIG. 2 is a schematic view of a detail of a further preferred embodiment of a secondary cell 1 according to the invention, in which foreign body 14 has passed through cell housing 6 and penetrated functional device 5. It is not shown that cell housing 6 and second potential area 7b are locally deformed by foreign body 14. Foreign body 14 does not reach as far as penetrating electrode assembly 2. However, foreign body 2 completes a current path, which creates an electrical connection between electrodes 3, 3a having different polarities. Electrode assembly 2 may be at least partly discharged via the current path. Potential areas 7a, 7b are preferably in the form of metal foils, and insulating area 7 is preferably in the form of a polymer film. Cell housing 6, functional device 5 and electrode assembly 2 are shown separately from each other only so that they can be distinguished more easily. This embodiment offers the advantage of greater operating safety of the secondary cell, due to the fact that functional device 5 provides further mechanical protection for electrode assembly 2 against penetration by a foreign body 14. This embodiment offers the advantage of greater operating safety of the secondary cell, due to the fact that functional device 5 serves as a current path for the at least partial discharge of electrode assembly 2.

FIG. 3 is a schematic view of secondary cell 1 of FIG. 2, in which foreign body 14 has penetrated electrode assembly 2. By puncturing separator 17, foreign body 14 has created a direct electrical connection between electrodes 3, 3a having different polarities. At the same time, potential areas 7b, 7a of functional device 5 are electrically connected. In this way, two current paths are created, via which electrode assembly 2 may be at least partially discharged. Potential areas 7a, 7b are preferably in the form of metal foils, and insulating area 7 is preferably in the form of a polymer film. Cell housing 6, functional device 5 and electrode assembly 2 are shown separately from each other only so that they can be distinguished more easily. This embodiment offers the advantage of greater operating safety of the secondary cell, due to the fact that functional device 5 serves as a current path for at least partially discharging electrode assembly 2.

FIG. 4 is a schematic view of a further preferred embodiment of secondary cell 1 according to the invention, in which foreign body 14 deforms functional device 5. In this embodiment, insulating area 7 is furnished with a plurality of openings 16, although only one opening 16 is illustrated. An electrical connection is created between potential areas 7a, 7b through opening 16, due to the fact that the deformed second potential area 7b extends as far as first potential area 7a. Insulating area 7 is preferably constructed as an electrically insulating coating on only one of potential areas 7a, 7b. Potential areas 7a, 7b are preferably in the form of metal foils. Cell housing 6, functional device 5 and electrode assembly 2 are shown separately from each other only so that they can be distinguished more easily. This embodiment offers the advantage of greater operating safety due to the fact that a deformation of even one of these potential areas, particularly the potential area closest to the cell housing, causes at least partial discharge of electrode assembly 2.

FIG. 5 is a schematic view of a detail of a preferred embodiment of functional device 5 with a puncture-protection layer 19 and an arrangement of electrical conductors 15, 15a. Puncture-protection layer 19 is arranged directly opposite the electrode assembly, which is not shown. Puncture-protection layer 19 preferably contains aramid fibres or is constructed as a ceramic oxide plate. A plurality of metallic conductors 15 are attached to the surface area of puncture-protection layer 19 closest to insulating area 7. These metallic conductors 15 are electrically connected to one of the electrodes of the electrode assembly. This embodiment offers the advantage of increased operating safety of the secondary cell due to the fact that functional device 5 provides electrode assembly 2 with further mechanical protection against penetration by a foreign body 14.

FIG. 5b shows an advantageous arrangement of electrical conductors 15, 15a attached to a carrier that is in the form of a puncture protection layer 19. Together, electrical conductors 15, 15a and puncture protection layer 19 form a potential area 7a of a preferred embodiment of the functional device. The other components of the functional device are not shown.

FIG. 6 is a schematic view of a detail of a preferred embodiment of functional device 5, in which insulating area 7 is furnished with an array of openings 16. Potential area 7a, which is underneath, is indicated by a dashed line. Electrical contact between the potential areas is possible through openings 16.

### LIST OF REFERENCE NUMBERS

1, 1a Electrochemical energy storage device, secondary cell
2, 2a Electrode assembly
3, 3a Electrode
4, 4a Current conductor device
5, 5a Functional device
6 Cell housing
7 Insulating area
7a, 7b Potential areas
8 Sheath
9 Discharge resistor
10 Display device
11 Sensor
12 Cell control device
13 Short-range radio device
14 Foreign body
15, 15a Electrical conductor
16 Opening
17 Separator
18 Pouch enclosing functional device
19 Puncture-protection layer

1.-10. (canceled)

11. A secondary cell of an electrochemical energy storage device, the secondary cell comprising:
an electrode assembly supplying electrical energy, the electrode assembly having two electrodes of different polarity;
a functional device electrically connected to the electrodes of different polarity and switchable between a first state and a second state, the electrodes of different polarity being electrically insulated from each other when the functional device is in the first state, and the electrodes of different polarity being electrically connected to each other when the functional device is in the second state; and
a cell housing including a first wall, the cell housing at least partially surrounding the electrode assembly and the functional device, the functional device being arranged between the first wall and the electrode assembly and having a predetermined electrical resistance in the second state.

12. The secondary cell as set forth in claim 11, wherein:
the cell housing encloses the electrode assembly.

13. The secondary cell as set forth in claim 12, further including:
two current conducting devices of different polarities conducting electrons between one of the electrodes and a consumer or between one of the electrodes and an adjacent secondary cell;
a sheath surrounding the electrode assembly;
a second electrode assembly, electrically connected to the first electrode assembly, supplying electrical energy to the consumer;
a discharge resistor electrically connected between one of the potential areas and one of the electrodes;
a display device for at least one of displaying the second state of the functional device and communicating an indication of the second state when a short circuit exists between the first potential area and the second potential area;
a sensor capturing an operating parameter of the electrode assembly;
a cell control device controlling the electrode assembly; and
a first short-range radio device for communication with a higher-level controller.

14. The secondary cell as set forth in claim 13, wherein:
the first potential area is electrically connected to the first current conducting device inside the cell housing; and
the second potential area is electrically connected to the second current conductor device inside the cell housing.

15. The secondary cell as set forth in claim 13, wherein:
the sheath is inside the cell housing.

16. The secondary cell as set forth in claim 13, wherein:
the electrode assembly is rechargeable; and
the second electrode assembly is rechargeable.

17. The secondary cell as set forth in claim 13, wherein:
the second electrode assembly is electrically connected in series to the first electrode assembly inside the cell housing.

18. The secondary cell as set forth in claim 13, wherein:
the discharge resistor is connected in a thermally conductive manner to the cell housing.

19. The secondary cell as set forth in claim 13, wherein:
the sensor is a temperature sensor; and
the operating parameter is a temperature of the electrode assembly.

20. The secondary cell as set forth in claim 13, wherein:
the sensor higher-level controller is a battery controller.

21. The secondary cell as set forth in claim 13:
the electrode assembly is arranged adjacent to the second electrode assembly inside cell housing;
wherein the electrode assembly is connected in series to the second electrode assembly; and
further including;
a second functional device; and
a second wall of the housing;
wherein each of the first and second functional devices is between one of the electrode assemblies and one of the walls of the cell housing.

22. The secondary cell as set forth in claim 11, the functional device comprising:
a first potential area electrically connected a first one of the electrodes having a first polarity;
a second potential area electrically connected to a second one of the electrodes having a second polarity; and
an electrically insulating area between the first potential area and the second potential area, the functional device is in the second state when the first potential area and the second potential area are electrically connected to each other.

23. The secondary cell as set forth in claim 22, wherein:
the first potential area and the second potential area are electrically connected to each other by an electrically conductive foreign body when the functional device is in the second state.

24. The secondary cell as set forth in claim 22, wherein:
at least one of the first potential area and the second potential area includes a puncture-protection layer;
at least one of the first potential area and the second potential area includes at least one electrical conductor, the at least one electrical conductor faces the insulating area, and the at least one electrical conductor is electrically connected to one of the electrodes; and
the insulating area includes at least one opening, the opening permitting electrical contact between the first potential area and the second potential area.

25. The secondary cell as set forth in claim 11, wherein:
the secondary cell has a nominal charge capacity of at least 3 Ah;
the secondary cell has a nominal current of at least 50 A;
the secondary cell has a nominal voltage of at least 1.2 V;
the secondary cell has an operating temperature range between −40° C. and +100° C.; and
the secondary cell has a gravimetric energy density of at least 50 Wh/kg.

26. The secondary cell as set forth in claim 25, wherein:
the nominal charge capacity is at least 10 Ah;
the nominal current is at least 100 A; and
the nominal voltage is at least 3.5 V.

27. A battery comprising at least two secondary cells as set forth in claim 11, a battery controller and at least one second short-range radio device.

28. A method for operating a secondary cell including an electrode assembly, supplying a consumer with electrical energy, having at least two electrodes of different polarities, a functional device, electrically connected to the at least two electrodes, switchable between a first state and a second state, the electrodes of different polarity being electrically connected to each other when the functional device is in the second state, a cell housing at least partially surrounding the electrode assembly and the functional device, the method including:
penetrating the functional device with a foreign body; and
electrically connecting the first potential area to the second potential area when the foreign body penetrates the functional device.

29. The method according to the claim 28, further including:
switching the electrode assembly to a third state, including:
dissipating an electrical current from the electrode assembly via a discharge resistor, the electrode assembly, while in the third state, having a predetermined residual charge lower than a nominal charge capacity of the secondary cell.

30. The method according to the claim 29, wherein the dissipating step includes:
dissipating the electrical current from the electrode assembly during a predetermined time interval.
